(19) United States
(12) Patent Application Publication
(10) Pub. No.: US 2015/0003563 A1
(43) Pub. Date: Jan. 1, 2015

(54) DISTORTION COMPENSATION APPARATUS, DISTORTION COMPENSATION METHOD, AND RADIO COMMUNICATION APPARATUS

(71) Applicant: FUJITSU LIMITED, Kawasaki-shi (JP)

(72) Inventors: Satoshi MATSUBARA, Kawasaki (JP); HIDEHARU SHAKO, Yokohama (JP); Mitsuharu HAMANO, Sendai (JP)

(73) Assignee: FUJITSU LIMITED, Kawasaki-shi (JP)

(21) Appl. No.: 14/278,001

(22) Filed: May 15, 2014

(30) Foreign Application Priority Data
Jun. 28, 2013 (JP) 2013-135762

(51) Int. Cl. H04B 15/00

(52) U.S. Cl. CPC H04B 15/00; H04B 2215/00; H04B 2001/0408
USPC 375/297

(57) ABSTRACT

A distortion compensation apparatus for compensating distortion of an input signal by an amplifier, the apparatus including: a storage unit configured to store a distortion compensation coefficient; a distortion compensation processing unit configured to read the distortion compensation coefficient from the storage unit based on a plurality of first addresses each corresponding to power of the input signal and perform distortion compensation on the input signal; and a distortion compensation coefficient copy unit configured to store the distortion compensation coefficient stored at a third address to a second address in which no distortion compensation coefficient is stored, between a maximum address and a minimum address of the storage unit storing the distortion compensation coefficients out of plurality of first addresses.

### CROSS-REFERENCE TO RELATED APPLICATION

This application is based upon and claims the benefit of priority of the prior Japanese Patent Application No. 2013-135762, filed on Jun. 28, 2013, the entire contents of which are incorporated herein by reference.

### FIELD

The embodiments discussed herein are related to a distortion compensation apparatus, a distortion compensation method, and a radio communication apparatus.

### BACKGROUND

With the recent progress of digital communication in a radio communication apparatus such as a feature phone and a smartphone, data transmission is performed with high efficiency. When multilevel phase modulation is applied as a data transmission method, nonlinear distortion may be produced in a transmission power amplifier.

FIG. 18 illustrates an input/output characteristic of a power amplifier. In the linear region of the power amplifier (a in FIG. 18), output-to-input power has a linear characteristic. In contrast, in the nonlinear region (β in FIG. 18), the output-to-input power comes to have a nonlinear characteristic, as depicted with the dotted line. By the above nonlinear characteristic, nonlinear distortion is generated on a transmission signal.

FIG. 19 illustrates an example of a frequency spectrum in the vicinity of a transmission frequency f0. The horizontal axis represents frequency and the vertical axis represents power. For example, due to the nonlinear distortion, the frequency spectrum in the vicinity of the transmission frequency f0 comes to have a characteristic depicted with a solid line 200 that varies from the characteristic depicted with a broken line 210. With this, for example, larger leakage power is produced to an adjacent frequency bandwidth, which causes the occurrence of spurious to the adjacent frequency bandwidth, to generate noise that deteriorates communication quality in the adjacent frequency bandwidth. Here, the spurious signifies an undesired frequency component or a signal component that is not intended in design, for example.

In a radio communication apparatus, a technique to linearize the input/output characteristic of a power amplifier is applied to suppress nonlinear distortion and reduce leakage power to an adjacent frequency channel. Also, to improve power efficiency using an amplifier of inferior linearity, a distortion compensation technique is employed to compensate nonlinear distortion.

As the distortion compensation technique, there is a pre-distortion (PD) method, for example. The PD method compensates the nonlinear characteristic by adding to an input signal an inverse characteristic to the nonlinear characteristic beforehand. Particularly, in a digital pre-distortion method to achieve the PD method by a digital signal, power consumption is quite small and therefore is widely used in a radio communication apparatus etc., as a distortion compensation technique.

As a method for achieving the DPD (digital pre-distortion) method, for example, an LUT (look up table) method is well known. According to the LUT method, a distortion compensation coefficient stored in an LUT is referred to and at an address thereof, updated based on the power value of an input signal. Nonlinear distortion is canceled because the characteristic of the distortion compensation coefficient stored in the LUT is an inverse characteristic to the input/output characteristic of a power amplifier, for example.

As techniques related to such distortion compensation, the following techniques have been disclosed, for example.

Namely, there is such a technique that, in regard to compensation data out of the distortion compensation range, the update of compensation data is prohibited, as contrasted with the prior art of a substitutive use of compensation data (or distortion compensation coefficient) at a lowermost address when an address is below the lower limit of a distortion compensation range, or compensation data at an uppermost address when exceeding the upper limit of a distortion compensation range. According to the above technique, because the compensation data is not updated when transmission power is out of the distortion compensation range, compensation data at the lowermost address or the uppermost address is always updated correctly. Therefore, it is urged that the deterioration of a distortion compensation characteristic caused by the update of the compensation data can be prevented.

Also, there is disclosed a distortion compensation apparatus in which a distortion compensation coefficient is acquired from a storage unit, based on a first address for acquiring a distortion compensation coefficient from the storage unit on the basis of the power value of an input signal, and a second address for acquiring a distortion compensation coefficient from the storage unit on the basis of an input signal phase, to compensate signal distortion produced by an amplifier. With the technique, it is urged that signal distortion can be compensated with high accuracy.

Further, there is another distortion compensation apparatus in which, by the segmentation of an address range, a representative address is set for each section, and in regard to a minimum or maximum representative address that is insufficient in view of a predetermined condition such as few number of sampling, zero-order extrapolation is made using a distortion compensation coefficient that is effectively acquired from the nearest representative address. It is urged that, with the above technique, distortion compensation can be performed effectively.

### PATENT DOCUMENTS

[Patent document 1] Japanese Laid-open Patent Publication No. 2001-284976.

[Patent document 2] Japanese Laid-open Patent Publication No. 2011-199428.

[Patent document 3] Japanese Laid-open Patent Publication No. 2011-254124.

However, according to the LUT method, there is a case when a distortion compensation coefficient is neither stored nor updated between the maximum address and the minimum address of the LUT in which each distortion compensation coefficient is stored. The cause is said to be the characteristic of an expression to generate an LUT address, for example. In to such a case, at an address where a distortion compensation coefficient is neither stored nor updated, there may occur a situation in which an ideal distortion compensation coefficient is not obtainable or it takes a long time to obtain an ideal distortion compensation coefficient. The occurrence of such a situation may generate a large error between an ideal distortion compensation coefficient and an actual distortion compensation coefficient. This error may cause the occurrence of the spurious.

As described above, for an address of the LUT that exceeds the maximum storage address of the distortion compensation coefficient, there is a technique to substitutively use a distortion compensation coefficient stored at the maximum address, or prohibit the update, for example.

However, the above-mentioned techniques do not mention a case when a distortion compensation coefficient is not stored, or updated, between the maximum address and the minimum address of an LUT in which each distortion compensation coefficient is stored, and a method for dealing therewith is not described. Therefore, by the above-mentioned techniques, it is not possible to reduce the occurrence of the spurious produced in such a case.

### SUMMARY

According to an aspect of the embodiments, a distortion compensation apparatus for compensating distortion of an input signal by an amplifier, the apparatus including: a storage unit configured to store a distortion compensation coefficient; a distortion compensation processing unit configured to read the distortion compensation coefficient from the storage unit based on a plurality of first addresses each corresponding to power of the input signal and perform distortion compensation on the input signal; and a distortion compensation coefficient copy unit configured to store the distortion compensation coefficient stored at a third address to a second address in which no distortion compensation coefficient is stored, between a maximum address and a minimum address of the storage unit storing the distortion compensation coefficients out of plurality of first addresses

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a radio communication apparatus.

FIG. 2 illustrates a configuration example of a PD unit.

FIG. 3 illustrates a configuration example of an address generation unit.

FIG. 4 illustrates an operation example of distortion compensation coefficient copy control.

FIGS. 5A, 5B illustrate examples of the existence or non-existence of a stored distortion compensation coefficient at an X-axis address.

FIG. 6 illustrates an example of the existence or non-existence of a stored distortion compensation coefficient at an X-axis address and a Y-axis address.

FIG. 7 is a flowchart illustrating an operation example of distortion compensation coefficient copy control.

FIG. 8 is a flowchart illustrating an operation example of distortion compensation coefficient copy control.

FIG. 9 illustrates an example of the existence or non-existence of a stored distortion compensation coefficient at an X-axis address and a Y-axis address.

FIG. 10 illustrates an operation example of distortion compensation coefficient copy control.

FIG. 11 illustrates an example of the existence or non-existence of a stored distortion compensation coefficient at an X-axis address.

FIG. 12 is a flowchart illustrating an operation example of distortion compensation coefficient copy control.

FIG. 13 is a flowchart illustrating an operation example of distortion compensation coefficient copy control.

FIG. 14 illustrates a configuration example of an address generation unit.

FIG. 15 illustrates a configuration example of an address generation unit.

FIG. 16 illustrates a configuration example of a radio communication apparatus.

FIG. 17 illustrates a configuration example of a radio communication apparatus.

FIG. 18 illustrates an example of an input/output characteristic of an amplifier.

FIG. 19 illustrates an example of a frequency spectrum in the vicinity of a transmission frequency f0.

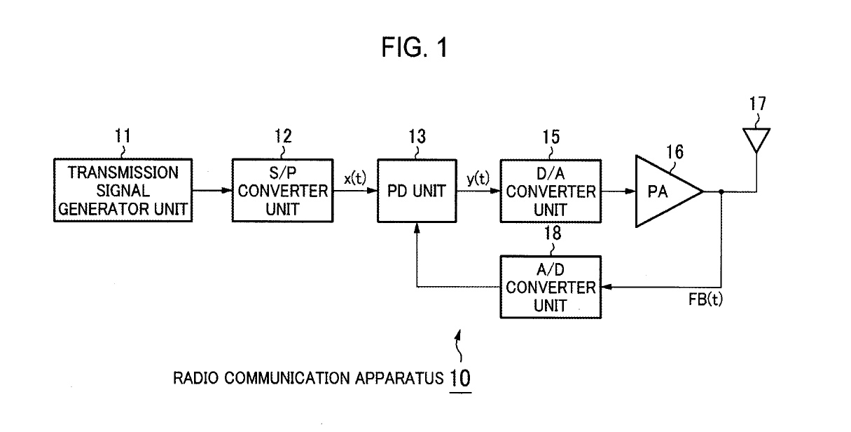

### DESCRIPTION OF EMBODIMENTS

Hereafter, embodiments to implement the present invention will be described.

### First Embodiment

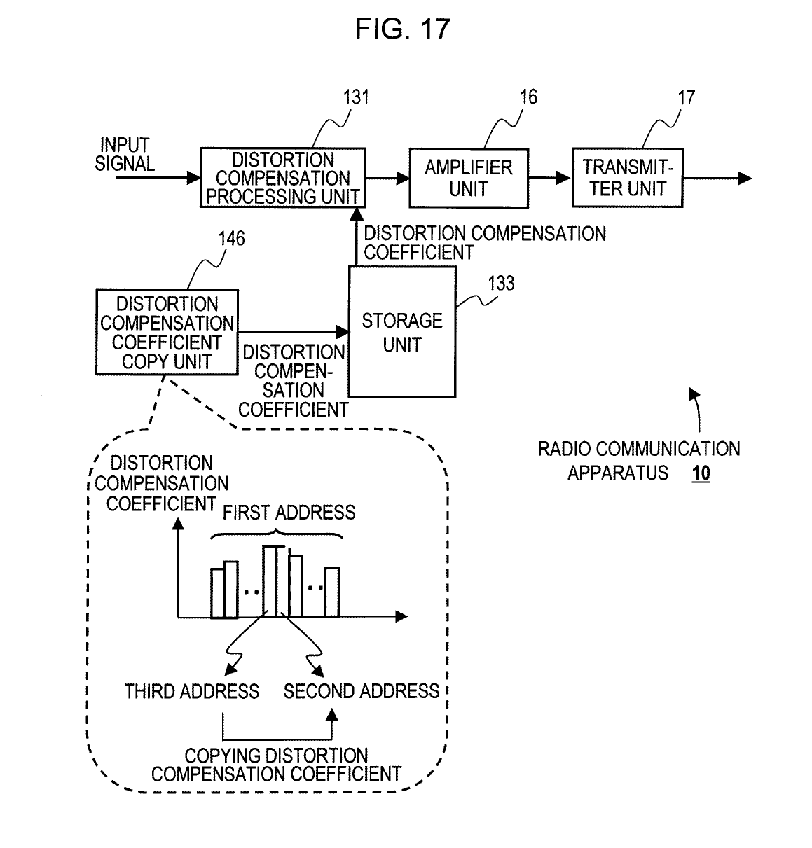

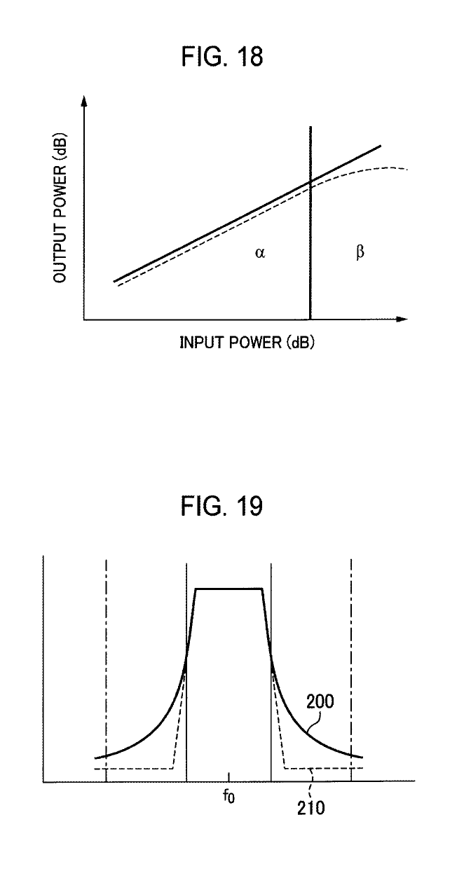

First, a description will be given on a first embodiment. FIG. 17 illustrates a configuration example of a radio communication apparatus 10 according to the first embodiment. The radio communication apparatus 10 may be a terminal apparatus such as a feature phone and a smartphone, or a radio base station apparatus that performs radio communication with the terminal apparatus.

The radio communication apparatus 10 includes an amplifier unit 16, a storage unit 133, a distortion compensation processing unit 131, a transmitter unit 17 and a distortion compensation coefficient copy unit 146.

The amplifier unit 16 amplifies an input signal. The storage unit 133 stores each distortion compensation coefficient. Based on a plurality of first addresses each corresponding to varied input signal power, the distortion compensation processing unit 131 reads out a distortion compensation coefficient from the storage unit 133, to perform distortion compensation on the input signal to compensate distortion in the input signal produced by the amplifier unit unit 16. The transmitter unit 17 transmits a distortion compensated input signal.

The distortion compensation coefficient copy unit 146 stores a distortion compensation coefficient stored at a third address to a second address in which no distortion compensation coefficient is stored, located between a maximum address and a minimum address of the storage unit 133, in which each distortion compensation coefficient is stored, among the plurality of first addresses.

As such, in the present radio communication apparatus 10, if a distortion compensation coefficient is neither stored nor updated between the maximum address and the minimum address of the LUT in which each distortion compensation coefficient is stored, it is possible to store a distortion compensation coefficient to an address in which no distortion compensation coefficient is stored.

Therefore, in the present radio communication apparatus 10, it is possible to reduce the occurrence of the spurious, if an ideal distortion compensation coefficient is unobtainable because a distortion compensation coefficient is neither stored nor updated between the maximum address and the minimum address of the LUT in which each distortion compensation coefficient is stored.

In the radio communication apparatus 10, an apparatus that includes the distortion compensation processing unit 131, the distortion compensation coefficient copy unit 146 and the storage unit 133 may be to referred to as a distortion compensation apparatus, for example.

### Second Embodiment

Next, a second embodiment will be described. First, a description will be given on a configuration example of a radio communication apparatus according to the present second embodiment.

<Configuration Example of Radio Communication Apparatus>

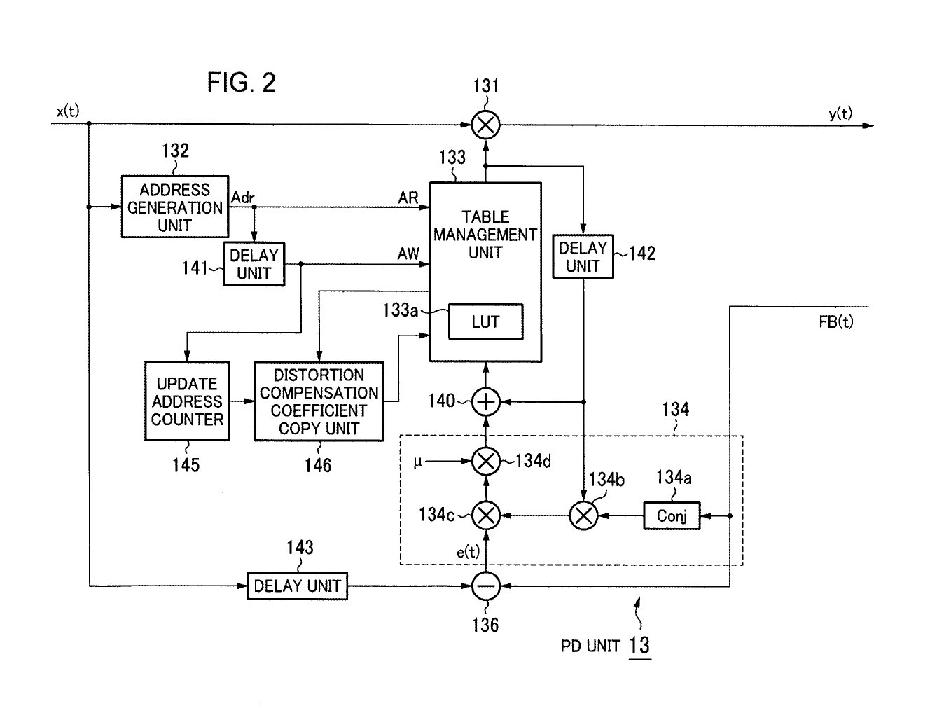

FIG. 2 illustrates a configuration example of a radio communication apparatus 10. The radio communication apparatus 10 includes a transmission signal generator unit 11, an S/P converter unit 12, a PD (pre-distortion) unit 13, a D/A (digital/analog) converter unit 15, a PA (power amplifier) 16, an antenna 17 and an A/D converter unit 18. The PD unit 13 may also be referred to as a distortion compensation unit or a distortion compensation apparatus, and the PA 16 may be referred to as an amplifier unit or a transmission amplifier, for example.

The transmission signal generator unit 11 generates a digital data sequence of a serial format transmitted from the radio communication apparatus 10. The transmission signal generator unit 11 outputs the generated digital data sequence to the S/P converter unit 12.

The S/P converter unit 12 alternately distributes bit-by-bit the digital data sequence output from the transmission signal generator unit 11, to convert into two series i.e. an in-phase component signal (I signal) and a quadrature component signal (Q signal). The S/P converter unit 12 outputs the converted I signal and the Q signal to the PD unit 13. The converted I signal and the Q signal may be referred to as an input signal (or transmission signal) x(t).

The PD unit 13 performs distortion compensation processing (for example, digital pre-distortion processing) on the input signal x(t), to output a distortion compensated input signal x(t) to the D/A converter unit 15. The distortion compensated input signal x(t) may be referred to as an output signal y(t), for example. Based on a feedback signal FB(t), which is a part of a signal amplified by the PA 16, and the input signal x(t) before distortion compensation, the PD unit 13 generates or updates a distortion compensation coefficient in an adaptive manner that a difference between the feedback signal FB(t) and the input signal x(t) becomes zero. Then, using the generated or updated distortion compensation coefficient, the PD unit 13 performs distortion compensation on the input signal x(t). The details of the PD unit 13 will be described later.

The D/A converter unit 15 converts the output signal y(t) into an analog signal, and outputs the converted analog signal to the PA 16.

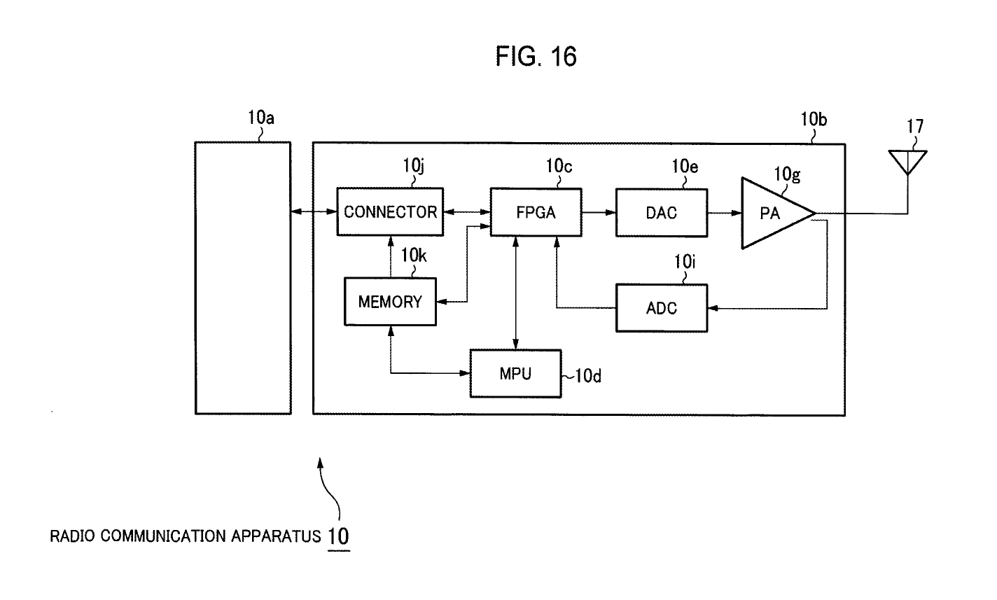

The PA 16, which includes a nonlinear distortion function f(p) as an amplification characteristic, amplifies a signal output from the D/A converter unit 15. The nonlinear distortion function f(p) is indicated as an input/output characteristic of a transmission amplifier depicted in FIG. 16, for example. An analog signal output from the PA 16 is output to the antenna 17, and also, a part of the analog signal is branched and output to the A/D converter unit 18 as a feedback signal FB(t). The PA 16 corresponds to the amplifier unit 16 of the first embodiment, for example.

The antenna 17 radiates the signal output from the PA 16 into the air to transmit the signal to another radio communication apparatus of an opposite communication party. The antenna 17 corresponds to the transmitter unit 17 of the first embodiment, for example.

The A/D converter unit 18 converts the feedback signal FB(t) into a digital signal to output to the PD unit 13.

<Configuration Example of PD Unit 13>

Next, a configuration example of the PD unit 13 will be described. FIG. 2 illustrates a configuration example of the PD unit 13. The PD unit 13 includes a multiplier unit 131, an address generation unit 132, a table management unit 133, a distortion compensation coefficient calculation unit 134, a subtractor unit 136, an adder unit 140, delay units 141-143, an update address counter 145 and a distortion compensation coefficient copy unit 146.

The multiplier unit 131 multiplies an input signal x(t) by a distortion compensation coefficient hₙ₋₁(p) output from the table management unit 133. For example, based on a first address corresponding to the power of the input signal, the multiplier unit 131 reads out a distortion compensation coefficient hₙ₋₁(p) from the table management unit 133, and performs distortion compensation on the input signal x(t) using the read-out distortion compensation coefficient hₙ₋₁(p). The multiplier unit 131 outputs the distortion compensated input signal x(t) to the D/A converter unit 15, as an output signal y(t). The multiplier unit 131 is also a distortion compensation processing unit that performs distortion compensation on the input signal x(t) using the distortion compensation coefficient hₙ₋₁(p), for example. The multiplier unit 131 corresponds to the distortion compensation processing unit 131 in the first embodiment, for example.

Based on the power value of the input signal x(t), the address generation unit 132 generates a first address to acquire a distortion compensation coefficient from the table management unit 133. For example, the address generation unit 132 calculates power p (=x²(t)) of the input signal x(t), and generates, as the first address, an address that uniquely corresponds to the calculated power p.

Also, based on the amplitude of the input signal x(t), the address generation unit 132 generates a second address to acquire a distortion compensation coefficient from the table management unit 133. For example, the address generation unit 132 calculates an amplitude difference Δ between different time points of the input signal x(t), and generates, as the second address, an address that uniquely corresponds to the calculated amplitude difference Δ.

The address generation unit 132 composes the generated first and second addresses to output, as a reference address Adr, a composite address to the table management unit 133 and the delay unit 141. The details of the address generation unit 132 will be described later. The above first address and the second address may also be referred to as an X-axis address and a Y-axis address, respectively, for example.

The table management unit 133 is a storage unit that stores each distortion compensation coefficient calculated by the distortion compensation coefficient calculation unit 134 and the subtractor unit 136. Typically, the table management unit 133 stores an LUT (look up table) 133a in which the distortion compensation coefficient is associated with a two-dimensional address. The two-dimensional address is a combined address of the X-axis address with the Y-axis address, for example.

The table management unit 133 reads out a distortion compensation coefficient from the LUT 133a, using the reference address Adr output from the address generation unit 132, as a readout address AR. Typically, the table management unit 133 acquires the X-axis address and the Y-axis address from the readout address AR. The table management unit 133 then reads out from the LUT 133a a distortion compensation coefficient corresponding to the acquired X-axis address and the Y-axis address. The table management unit 133 outputs the read-out distortion compensation coefficient hₙ₋₁(p) to the multiplier unit 131 and the delay unit 142.

Also, the table management unit 133 stores (or updates) a distortion compensation coefficient (or an update value of a distortion compensation coefficient), using the reference address Adr output from the delay unit 141, as a write address AW. Typically, the table management unit 133 acquires the X-axis address and the Y-axis address from the write address AW, and stores the distortion compensation coefficient output from the adder unit 140 to an address corresponding to the acquired X-axis address and the Y-axis address.

The table management unit 133 corresponds to the storage unit 133 in the first embodiment, for example.

The subtractor unit 136 and the distortion compensation coefficient calculation unit 134 calculate a distortion compensation coefficient, on the basis of the input signal x(t) before distortion is compensated by the multiplier unit 131 and the feedback signal FB(t).

Namely, the subtractor unit 136 calculates a difference between the input signal x(t) output from the delay unit 143 and the feedback signal FB(t) output from the A/D converter unit 18, so as to output the calculated difference to the distortion compensation coefficient calculation unit 134, as a difference signal e(t).

Based on the difference signal e(t) and the distortion compensation coefficient stored at the LUT 133a, the distortion compensation coefficient calculation unit 134 calculates an update value of the distortion compensation coefficient. The distortion compensation coefficient calculation unit 134 outputs the update value of the distortion compensation coefficient to the adder unit 140.

The distortion compensation coefficient calculation unit 134 includes a conjugate complex signal output unit (Conj) 134a and multiplier units 134b-134d.

The conjugate complex signal output unit 134a generates a conjugate complex signal FB*(t) for the feedback signal FB(t), to output the generated conjugate complex signal FB*(t) to the multiplier unit 134b.

The multiplier unit 134b multiplies the distortion compensation coefficient hₙ₋₁(Adr) output from the delay unit 142 by the conjugate complex signal FB*(t), to output the multiplication result u*(t) (=hₙ₋₁(Adr)FB*(t)) to the multiplier unit 134c.

The multiplier unit 134c multiplies the difference signal e(t) output from the subtractor unit 136 by the multiplication result u*(t), to output the multiplication result e(t)u*(t) to the multiplier unit 134d.

The multiplier unit 134d multiplies the multiplication result e(t)u*(t) by a step-size parameter μ, and outputs the multiplication result μe(t)u*(t) to the adder unit 140.

The adder unit 140 adds the multiplication result μe(t)u*(t), which is output from the multiplier unit 134d, to the distortion compensation coefficient hₙ₋₁(p) which is output from the delay unit 142, and outputs the addition result (=hₙ₋₁(Adr)+μe(t)u*(t)) to the table management unit 133, as an update value of the distortion compensation coefficient. The update value output from the adder unit 140 is stored into an area of the LUT 133a that corresponds to the write address AW input to the table management unit 133, for example.

The delay units 141-143 add, to the input signal x(t), a delay time D from the time when the input signal x(t) is input to the PD unit 13 to the time when the feedback signal FB(t) is input to the subtractor unit 136.

With such a configuration, the following calculation is performed.

hₙ(Adr)=hₙ₋₁(Adr)+μe(t)u*(t)

e(t)=x(t)−FB(t)

FB(t)=hₙ₋₁(Adr)×(t)f(Adr)

u*(t)=x(t)f(p)=hₙ₋₁(Adr)FB*(t)

where, x, FB, f, h, u and e represent complexes, * represents a conjugate complex, and Adr represents a reference address generated from x(t).

The PD unit 13 performs the above calculation processing to update the distortion compensation coefficient hₙ₋₁(Adr) in a manner to minimize the difference signal e(t) between the input signal x(t) and the feedback signal FB(t). By this, for example, the distortion compensation coefficient finally converges to an optimal distortion compensation coefficient, so that the distortion of the transmission signal (y(t) for example) in the PA 16 is compensated.

The update address counter 145 counts X-axis addresses and Y-axis addresses in the LUT 133a, for example. The update address counter 145 then discriminates whether or not the distortion compensation coefficient is updated at each counted address (xadr, yadr), based on the write address AW output from the delay unit 141.

The update address counter 145 performs counting in a manner as follows, for example. The update address counter 145, with a Y-axis address fixed to a minimum value of the LUT 133a, counts each X-axis address from a minimum value to a maximum value. Then the update address counter 145 adds one to the Y-axis address to fix the Y-axis address to the minimum value+1, and counts the X-axis addresses from the minimum value to the maximum value. The update address counter 145 adds one to the Y-axis address, and repeats the above processing. Finally, with the Y-axis address fixed to the maximum value of the LUT 133a, the update address counter 145 counts the X-axis address from the minimum value to the maximum value. For each address (xadr, yadr) counted in such a manner, the update address counter 145 discriminates whether or not each distortion compensation coefficient is updated.

The update address counter 145 discriminates whether or not the distortion compensation coefficient is updated in a manner as follows, for example. Namely, by discriminating whether or not each counted address (xadr, yadr) coincides with the write address AW fed from the delay unit 141, the update address counter 145 discriminates whether or not the distortion compensation coefficient at the address is updated.

For example, in an area of the LUT 133a that corresponds to the write address AW in the LUT 133a, the distortion compensation coefficient is updated (or stored). Therefore, if the counted address (xadr, yadr) is coincident with the write address AW, the distortion compensation coefficient at the address of concern (xadr, yadr) comes to be updated. On the other hand, if the counted address (xadr, yadr) is not coincident with the write address AW, the distortion compensation coefficient at the address (xadr, yadr) is not updated.

The update address counter 145 outputs to the distortion compensation coefficient copy unit 146 each counted address (xadr, yadr) and the discrimination result that indicates whether or not the distortion compensation coefficient is updated. Here, the update address counter 145 outputs the above discrimination result to the distortion compensation coefficient copy unit 146 as an update flag, for example.

The distortion compensation coefficient copy unit 146 updates the distortion compensation coefficient in the LUT 133a, based on each counted address (xadr, yadr) and the discrimination result (or the update flag) that indicates whether or not the distortion compensation coefficient is updated.

Typically, on the acquisition of a discrimination result indicating that the distortion compensation coefficient at the address (xadr, yadr) is updated, the distortion compensation coefficient copy unit 146 retains the updated distortion compensation coefficient in an internal memory etc, as a distortion compensation coefficient for copy. Further, on the acquisition of a discrimination result indicating that the distortion compensation coefficient is not updated at an address (xadr+1, yadr), which is next to the address obtained by the above counting method, the distortion compensation coefficient copy unit 146 stores the distortion compensation coefficient for copy to the address (xadr+1, yadr). In such a manner, the distortion compensation coefficient is copied.

Here, it may also be possible that the update address counter 145 outputs the information of the write address AW to the distortion compensation coefficient copy unit 146 intact, and the distortion compensation coefficient copy unit 146 discriminates whether or not the distortion compensation coefficient at the address (xadr, yadr) is updated.

In the above-mentioned example, a description has been given on such an example that the address generation unit 132 generates and outputs a composite address of the X-axis address with the Y-axis address. However, it may also be possible for the address generation unit 132 to output the X-axis address and the Y-axis address to the table management unit 133, because it is satisfactory if the table management unit 133 may acquire the X-axis address and the Y-axis address.

Further, a distortion compensation apparatus may be configured of the multiplier unit 131, the table management unit 133 and the distortion compensation coefficient copy unit 146.

<Configuration Example of Address Generation Unit 132>

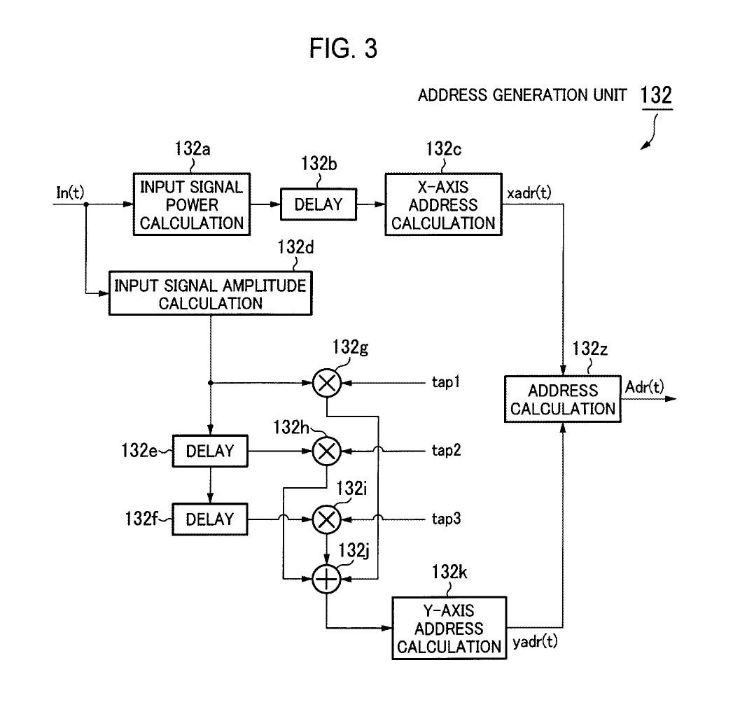

Next, a configuration example of the address generation unit 132 will be described. FIG. 3 illustrates the configuration of the address generation unit 132. The address generation unit 132 includes an input signal power calculation unit 132a, a delay unit 132b, an X-axis address calculation unit 132c, an input signal amplitude calculation unit 132d, delay units 132e, 132f, multiplier units 132g-132i, an adder unit 132j, a Y-axis address calculation unit 132k and an address calculation unit 132z.

The input signal power calculation unit 132a, the delay unit 132b and the X-axis address calculation unit 132c acquire a first address to acquire a distortion compensation coefficient from the table management unit 133, based on the power value (or power) of the input signal x(t) input to the address generation unit 132, for example.

Namely, the input signal power calculation unit 132a calculates power p (=x²(t)) of the input signal x(t).

The delay unit 132b inputs a power calculation result indicative of the power p output from the input signal power calculation unit 132a, and delays the power calculation result as long as a Y-axis address generation processing time, to output the delayed power calculation result to the X-axis address calculation unit 132c.

The X-axis address calculation unit 132c then normalizes the delayed power calculation result to calculate an X-axis address, and outputs the calculated X-axis address xadr(t) (=X-axis direction address P) to the address calculation unit 132z.

The input signal amplitude calculation unit 132d, the delay units 132e, 132f, the multiplier units 132g-132i, the adder unit 132j and the Y-axis address calculation unit 132k generate a second address to acquire a distortion compensation coefficient from the table management unit, based on the amplitude of the input signal x(t), for example.

Namely, the input signal amplitude calculation unit 132d calculates the amplitude of the input signal x(t). For example, the input signal amplitude calculation unit 132d calculates a half of a difference between a maximum value and a minimum value of the input signal x(t) during a predetermined period to determine to be the amplitude, or calculates a difference between the maximum value and an average value of the input signal x(t) to determine to be the amplitude. For example, by retaining a calculation formula to calculate the amplitude, the input signal amplitude calculation unit 132d calculates the amplitude according to the calculation formula. The input signal amplitude calculation unit 132d outputs the calculated amplitude information indicative of amplitude to the delay unit 132e and the multiplier unit 132g.

The delay unit 132e delays the amplitude information by one sample time of the input signal x(t), to output to the delay unit 132f and the multiplier unit 132h. The delay unit 132f delays the amplitude information output from the delay unit 132e by one sample time of the input signal x(t), to output to the multiplier unit 132i.

The multiplier unit 132g multiplies the amplitude information by a tap coefficient tap1, so as to output the multiplication result to the adder unit 132j. The multiplier unit 132h multiplies the amplitude information output from the delay unit 132e by a tap coefficient tap2, so as to output the multiplication result to the adder unit 132j. The multiplier unit 132i multiplies the amplitude information output from the delay unit 132f by a tap coefficient tap3, to output to the adder unit 132j.

The adder unit 132j adds each multiplication result output from the multiplier units 132g-132i. The addition result by the adder unit 132j indicates an amplitude difference Δ of the input signal x(t) at three different time points (for example, the present, the past and the future). Here, instead of the three time points, the address generation unit 132 may calculate the amplitude difference using each amplitude difference at four or more time points. The adder unit 132j outputs the addition result to the Y-axis address calculation unit 132k, as amplitude difference information.

The Y-axis address calculation unit 132k, by normalizing the amplitude difference information output from the adder unit 132j, calculates a Y-axis address. The Y-axis address calculation unit 132k outputs the calculated Y-axis address yadr(t) (=Y-axis direction address ΔP) to the address calculation unit 132z.

As such, the address generation unit 132 generates the Y-axis address on the basis of the difference between the amplitude calculated in the input signal amplitude calculation unit 132d and the amplitude obtained by delaying the calculated amplitude by a predetermined time (for example, one sample time).

The address calculation unit 132z composes the X-axis address xadr(t) with the Y-axis address yadr(t), to output a composite address Adr(t) to the delay unit 141 and the table management unit 133.

A delay amount in each delay unit 132e, 132f may be a period of a ½ sample, two samples, or the like, not necessarily limited to one sample of the input signal x(t). A delay amount in each delay unit 132b, 132e, 132f is adjusted in such a manner that, in the address calculation unit 132z, the input timing of the X-axis address xadr(t) coincides with the input timing of the Y-axis address yadr(t), for example.

<Operation Example>

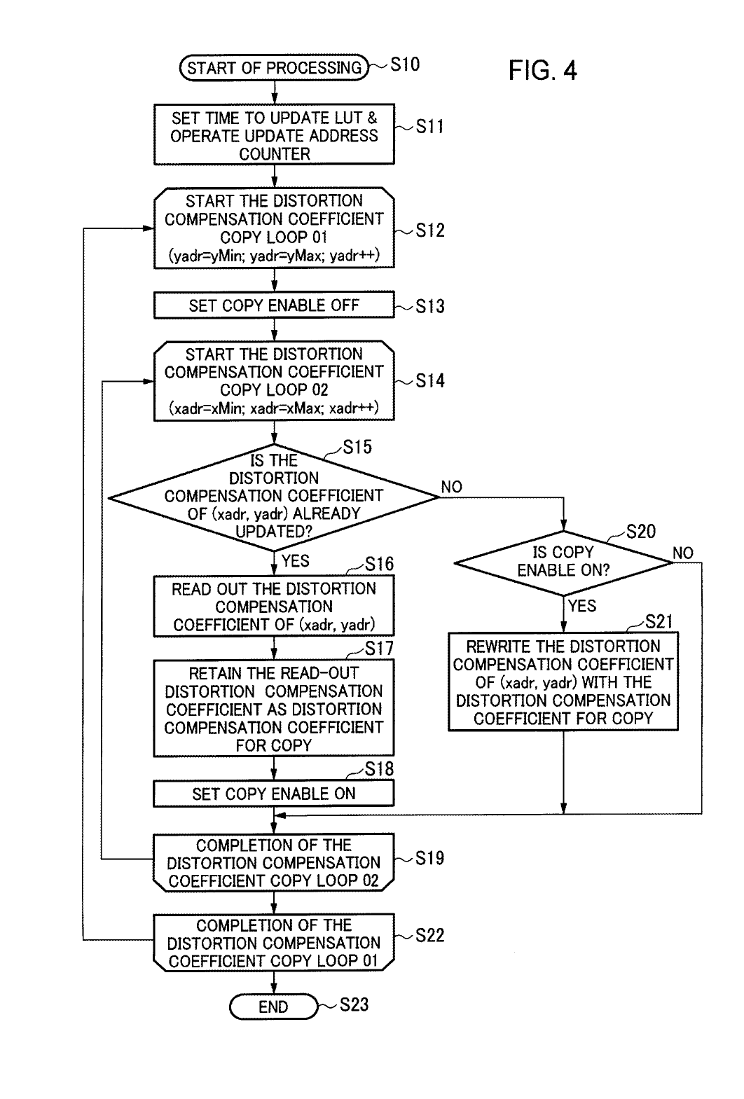

Next, an operation example of the second embodiment will be described. FIG. 4 is a flowchart illustrating an operation example of the present second embodiment. The flowchart depicted in FIG. 4 is an operation example of distortion compensation coefficient copy control, for example, which is mainly executed in the update address counter 145 and the distortion compensation coefficient copy unit 146.

The PD unit 13, on starting processing (S10), sets a time to update the LUT 133a, and starts the operation of the update address counter 145 (S11). For example, a user operation on the radio communication apparatus 10 (or the PD unit 13) enables setting a time to update the LUT 133a and operating the update address counter 145.

Next, the PD unit 13 starts a distortion compensation coefficient copy loop 01 (S11). In the distortion compensation coefficient copy loop 01, the PD unit 13 repeats processing from S13 to S22.

For example, in the distortion compensation coefficient copy loop 01, the update address counter 145 sets a minimum value yMIN and a maximum value yMAX for the Y-axis address yadr of the LUT 133a, and executes processing S13 and thereafter, with a Y-axis address yadr fixed to the minimum value yMIN. On completion of processing up to S22, the update address counter 145 increments the Y-axis address yadr by one address, to fix to the minimum value yMIN+1, to execute processing from S13 to S22. On completion of processing up to S22, the update address counter 145 increments the Y-axis address yadr by one address, to set the Y-axis address yadr to be the minimum value yMIN+2 and execute processing from S13 to S22. Thereafter, the update address counter 145 increments the Y-axis address yadr one-by-one, to execute processing from S13 to S22. When the Y-axis address yadr reaches the maximum value yMAX, the update address counter 145 fixes the Y-axis address yadr to the maximum value yMAX, and executes processing up to S22.

Here, the minimum value yMIN and the maximum value yMAX of the Y-axis address are retained in an internal memory etc. of the update address counter 145, and are read out and set at the present processing, for example.

Now, the PD unit 13 sets a copy enable flag OFF (S13). The copy enable flag indicates whether or not the copy operation of the updated distortion compensation coefficient can be executed. When the copy enable flag is ON, the distortion compensation coefficient copy unit 146 executes copy operation.

For example, the distortion compensation coefficient copy unit 146 retains information related to the copy enable flag ON or OFF in the internal memory etc., and executes the present processing (S13) by storing in the internal memory etc.

Incidentally, it is satisfactory if the present processing (S13) is executed during a period from S11 to S15.

Next, the PD unit 13 starts a distortion compensation coefficient copy loop 02 (S14). In the distortion compensation coefficient copy loop 02, the PD unit 13 repeats processing from S15 to S19.

For example, in the distortion compensation coefficient copy loop 02, the update address counter 145 sets a minimum value xMIN and a maximum value xMAX for the X-axis address xadr of the LUT 133a, and executes processing S15 and thereafter with an X-axis address xadr fixed to the minimum value xMIN. On completion of processing up to S19, the update address counter 145 increments the X-axis address xadr by one address to fix to the minimum value xMIN+1, to execute processing from S15 to S19. On completion of processing up to S19, the update address counter 145 increments the X-axis address xadr by one address, to set the X-axis address xadr to be the minimum value xMIN+2, and executes processing from S15 to S19. Thereafter, the update address counter 145 increments the X-axis address xadr one-by-one to execute processing from S15 to S19. When the X-axis address xadr reaches the maximum value xMAX, the update address counter 145 fixes the X-axis address xadr to xMAX, and executes processing up to S19.

Here, the minimum value xMIN and the maximum value xMAX of the X-axis address are retained in the internal memory of the update address counter 145, and are read out and set at the present processing, for example.

Thus, using the distortion compensation coefficient copy loop 01 (S12) and the distortion compensation coefficient copy loop 02, the update address counter 145 counts each address (xMIN, yMIN), (xMIN+1, yMIN) . . . (xMAX, yMIN) in the first loop (loop from S14 to S19).

Then, in the next loop, the update address counter 145 counts each address (xMIN, yMIN+1), (xMIN+1, yMIN+1) . . . (xMAX, yMIN+1). Thereafter, the update address counter 145 repeats the above processing, so as to count, in the final loop, each address (xMIN, yMAX), (xMIN+1, yMAX) . . . (xMAX, yMAX). For each counted address (xadr, yadr), the update address counter 145 and the distortion compensation coefficient copy unit 146 execute processing from S15 to S19.

Next, the PD unit 13 discriminates whether or not each distortion compensation coefficient at each counted address (xadr, yadr) is updated (S15).

For example, the update address counter 145 performs the discrimination based on whether the write address AW coincides with the each counted address (xadr, yadr).

Typically, if a counted address (xadr, yadr) coincides with the write address AW, the update address counter 145 discriminates that the distortion compensation coefficient at the address (xadr, yadr) has been updated. On the other hand, if a counted address (xadr, yadr) does not coincide with the write address AW, the update address counter 145 discriminates that the distortion compensation coefficient has not been updated.

When discriminating that the distortion compensation coefficient at the address (xadr, yadr) has been updated (YES in S15), the PD unit 13 reads out the distortion compensation coefficient at the address (xadr, yadr) from the LUT 133a (S16).

For example, the update address counter 145 outputs the discrimination result, indicating the distortion compensation coefficient is updated, and the corresponding address (xadr, yadr) to the distortion compensation coefficient copy unit 146. On receiving the discrimination result, the distortion compensation coefficient copy unit 146 outputs the received address (xadr, yadr) to the table management unit 133, and reads out from the table management unit 133 the distortion compensation coefficient stored at the address (xadr, yadr) of the LUT 133a.

Next, the PD unit 13 retains the read-out distortion compensation to coefficient as a distortion compensation coefficient for copy (S17). For example, the distortion compensation coefficient copy unit 146 retains the distortion compensation coefficient read out from the LUT 133a in the internal memory etc.

Next, the PD unit 13 sets a copy enable flag ON (S18). For example, the distortion compensation coefficient copy unit 146 rewrites the information of the copy enable flag retained in the internal memory etc. from OFF to ON.

The PD unit 13 then completes the distortion compensation coefficient copy loop 02 and shifts to S14. After shifting to S14, the PD unit 13 fixes the Y-axis address and increments the X-axis address by one, to execute processing S15 and after, using the incremented address (xadr+1, yadr) as an address (xadr, yadr).

On the other hand, if the distortion compensation coefficient at the address (xadr, yadr) is not updated (NO in S15), the PD unit 13 discriminates whether or not the copy enable flag is ON (S20).

For example, the distortion compensation coefficient copy unit 146 receives from the update address counter 145 the discrimination result indicating that the distortion compensation coefficient is not updated and the address (xadr, yadr) that produces the above discrimination result. The distortion compensation coefficient copy unit 146 then reads out the copy enable flag stored in the internal memory, to confirm whether or not the copy enable flag is ON.

When the copy enable flag is ON (YES in S20), the PD unit 13 stores the distortion compensation coefficient for copy to the address of concern (xadr, yadr) of the LUT 133a (S21).

In this case, the distortion compensation coefficient is not updated (or stored) at the address (xadr, yadr), and accordingly, a distortion compensation coefficient is read out from an address in which the distortion compensation coefficient is stored and which is located precedent to the to address (xadr, yadr) and nearest to the address (xadr, yadr), for example. Then, the above read-out distortion compensation coefficient is updated as a distortion compensation coefficient at the address (xadr, yadr).

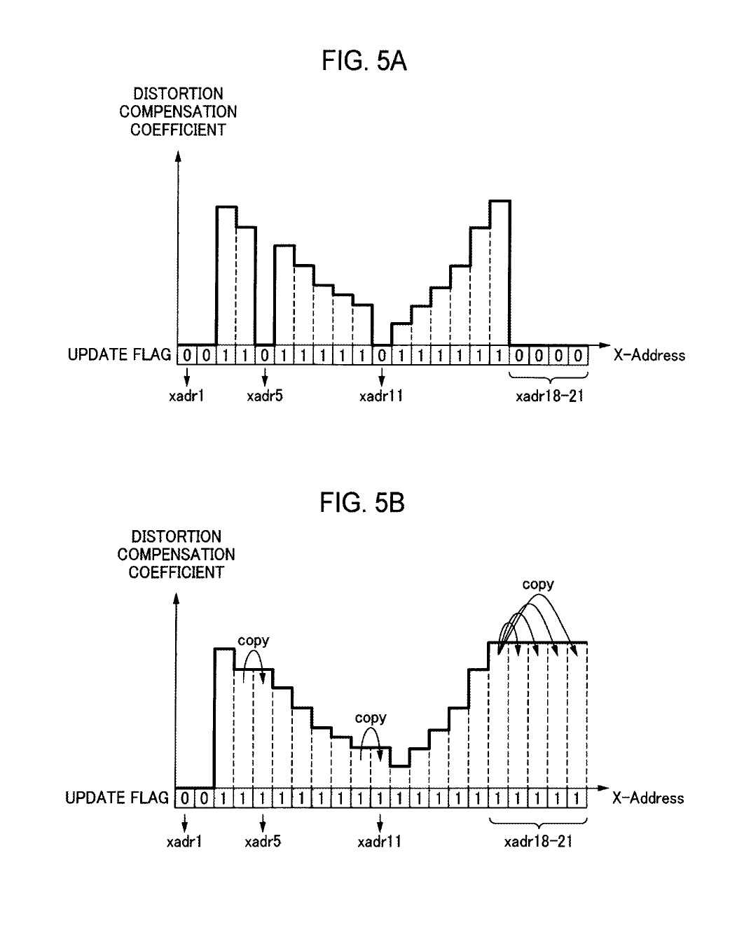

FIG. 5A illustrates an example of the existence or non-existence of an updated distortion compensation coefficient at each X-axis address xadr of the LUT 133a. The example depicted in FIG. 5A represents a case when the Y-axis address is fixed to a certain address.

In FIG. 5A, the distortion compensation coefficient is not updated at an X-axis address xadr5. In contrast, the distortion compensation coefficient is updated at an immediately preceding X-axis address xadr4. In the distortion compensation coefficient copy loop 02 depicted in FIG. 4, if a counted address is (xadr4, yadr), a distortion compensation coefficient at the address (xadr4, yadr) is copied in S17, and the copy enable flag is set ON. In the next loop, because a distortion compensation coefficient at an address (xadr5, yadr) has not been updated (NO in S15), and the copy enable flag is ON (YES in S20), copy operation to the address (xadr5, yadr) is executed. Namely, the distortion compensation coefficient copy unit 146 copies the distortion compensation coefficient from the immediately preceding address (xadr4, yadr), and stores the copied distortion compensation coefficient to the address (xadr5, yadr).

FIG. 5B illustrates an example of the existence or non-existence of an updated distortion compensation coefficient at each X-axis address after the copy is executed. To an X-axis address xadr5, the distortion compensation coefficient of an address xadr4, which is the immediately precedent address of the X-axis address xadr (i.e. of a smaller address number), is updated. To another address xadr11, the distortion compensation coefficient of an address xadr10 that is the immediately preceding X-axis address xadr is copied also.

In the case when the distortion compensation coefficient is not updated between a maximum reference value (xadr17 in the example of FIG. 5B) and a minimum reference value (xadr2 in the example of FIG. 5B) of the LUT 133a (namely, xadr5 and xadr11 in the example of FIG. 5B), the PD unit 13 stores each updated distortion compensation coefficient at the immediately preceding addresses (addresses xadr4, xadr10 in the example of FIG. 5B) to the addresses xadr5, 11.

Therefore, the PD unit 13 can perform distortion compensation on a transmission signal (or input signal x(t)) using the copied distortion compensation coefficient. By this, it is possible to reduce the spurious produced by an error between an ideal distortion compensation coefficient and an actual distortion compensation coefficient due to a non-updated distortion compensation coefficient.

Here, the maximum reference value is a distortion compensation coefficient stored at an address of the largest address number among the distortion compensation coefficients stored at the LUT 133a. Also, the minimum reference value is a distortion compensation coefficient stored at an address of the smallest address number among the distortion compensation coefficients stored at the LUT 133a, for example.

As illustrated in FIG. 5B, by the present distortion compensation coefficient copy control, the PD unit 13 can copy each distortion compensation coefficient for each address between an address larger than the maximum reference value of the X-axis address (for example, xadr17) and an address of the maximum value (for example, xadr11).

Nonlinear distortion is produced at input power larger than a threshold when the distortion compensation coefficient using the LUT 133a is executed, for example. A frequency when such input power appears is smaller than other input power. Therefore, the frequency of appearance of X-axis addresses that correspond to the input power larger than the threshold is smaller than the frequency of appearance of other X-axis addresses, and accordingly, a frequency of update of the distortion compensation coefficient becomes smaller. However, because the update of distortion compensation coefficients is performed also at each address xadr18-21 as depicted in FIG. 5B, the deterioration of a transmission signal due to linear distortion can also be prevented.

With reference back to FIG. 4, when the PD unit 13 updates the distortion compensation coefficient of the address (xadr, yadr) using the distortion compensation coefficient for copy (S21), the PD unit 13 completes the distortion compensation coefficient copy loop 02 (S19), and shifts to S14 again.

The PD unit 13 increments the X-axis address by one, and for the incremented address, executes processing from S15 to S19. After repeating the processing from S14 to S19 up to the maximum value xMAX of the X-axis address xadr, the PD unit 13 completes the distortion compensation coefficient copy loop 01 (S22).

The processing is shifted again to S12. After incrementing the Y-axis address by one, the PD unit 13 repeats the processing from S13 to S22. On completion of processing for the Y-axis address to the maximum value yMAX (S22), the PD unit 13 completes a series of processing (S23).

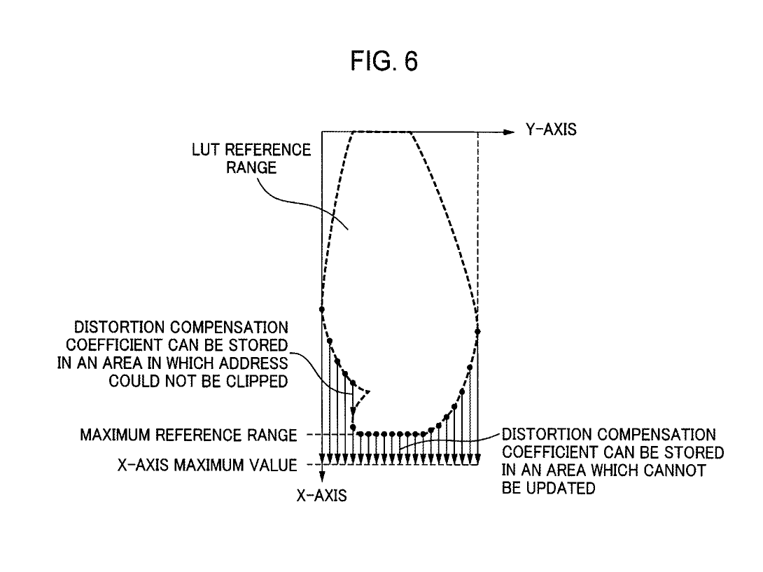

FIG. 6 illustrates an example of the existence or non-existence of an updated distortion compensation coefficient at the X-axis address and the Y-axis address of the LUT 133a. For example, the PD unit 13 performs processing from the minimum value yMIN to the maximum value yMAX of the Y-axis address. Thus, it is possible to finally obtain the result depicted in FIG. 6, for example. As depicted in FIG. 6, by the execution of the distortion compensation coefficient copy control (for example, FIG. 4) by the PD unit 13, each distortion compensation coefficient is updated even in the area of the LUT 133a in which the copy of the distortion compensation coefficient has not been possible.

In FIG. 6, there is a description of “address clipping”. The address clipping signifies a technique to fix the distortion compensation coefficient corresponding to each address which is larger than a predetermined threshold, for example.

As such, the distortion compensation coefficient copy unit 146 stores a distortion compensation coefficient, which is stored at a third address, to a second address in which no distortion compensation coefficient is stored, to located between the maximum address and the minimum address of the LUT 133a in which each distortion compensation coefficient is stored among the plurality of first addresses, for example.

Therefore, even when a distortion compensation coefficient is not updated between the minimum address and the maximum address of the LUT 133a in which each distortion compensation coefficient is stored, the present PD unit 13 can update the distortion compensation coefficient. Therefore, the PD unit 13 can reduce the occurrence of the spurious.

Also, the PD unit 13, with a fixed Y-axis address of the LUT 133a, successively increments the X-axis address to execute processing for each address. Therefore, according to the present distortion compensation coefficient copy control, a processing amount can be reduced as compared to an example in which the processing of successively incrementing the Y-axis address with a fixed X-axis address is added. Thus, the PD unit 13 can suppress an increased circuit scale caused by an increased memory capacity etc.

In the above-mentioned second embodiment, the description has been made on the processing example in which, in the distortion compensation coefficient copy loops 01, 02, the PD unit 13 fixes the Y-axis address of the LUT 133a and shifts the X-axis address from the minimum value to the maximum value. In a third embodiment and after, there will be described examples of copying the distortion compensation coefficient to a variety of address directions of the LUT 133a.

### Third Embodiment

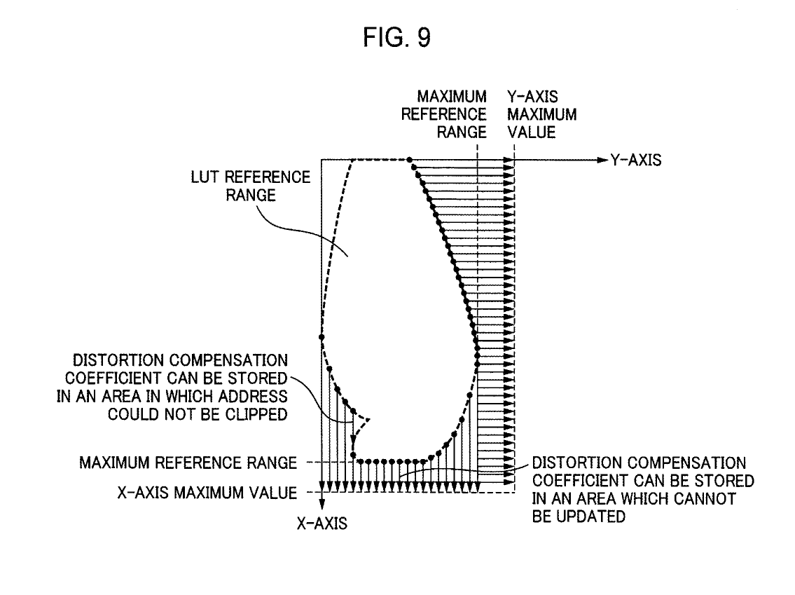

In a third embodiment, similar to the second embodiment, the PD unit 13 executes processing by shifting an X-axis address from the minimum value to the maximum value, with a fixed Y-axis address of the LUT 133a. Thereafter, the PD unit 13 executes processing by shifting a Y-axis address from the minimum value to the maximum value, with a fixed X-axis address. In the present third embodiment, there is illustrated an example in which to processing is executed in the positive direction of the Y-axis, not only in the positive direction of the X-axis, as depicted in FIG. 9 for example.

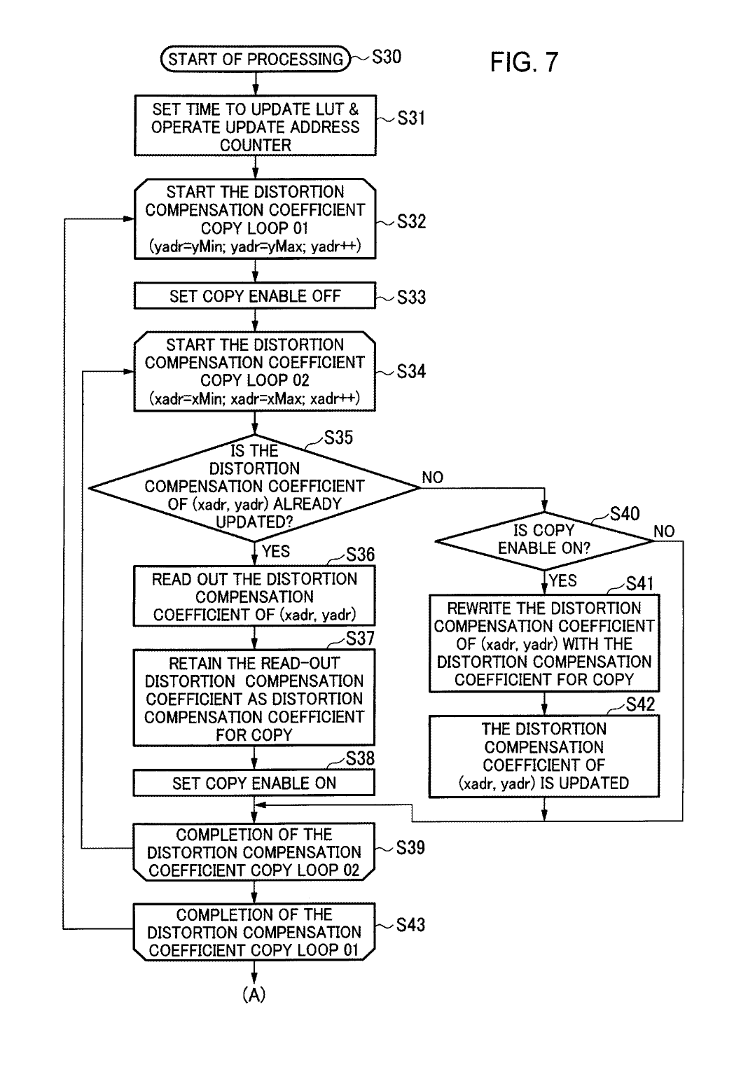

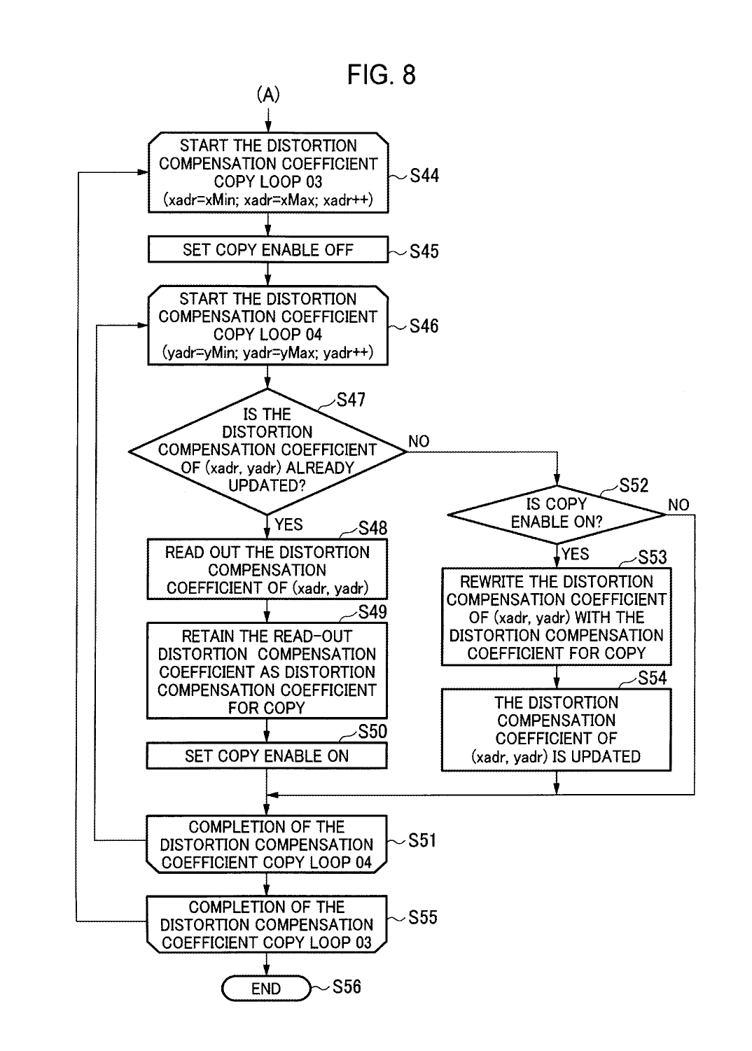

FIGS. 7, 8 are flowcharts illustrating an operation example of distortion compensation coefficient copy control according to the present third embodiment. Processing from S30 to S43 depicted in FIG. 7 is similar to the operation example of the distortion compensation coefficient copy control (for example, FIG. 4) in the second embodiment. Therefore, the description is omitted.

On completion of processing up to S43, the PD unit 13 executes processing from S44 and after, as illustrated in FIG. 8. The PD unit 13 executes a distortion compensation coefficient copy loop 03 for each X-axis address of the LUT 133a (S44), and after setting the copy enable flag OFF (S45), executes a distortion compensation coefficient copy loop 04 (S46) for each Y-axis address of the LUT 133a.

Using the distortion compensation coefficient copy loops 03, 04 (S44, S46), the PD unit 13, with an X-axis address xadr fixed to the minimum value xMIN, executes processing from S47 to S51 for each address of the Y-axis address yadr from the minimum value yMIN to the maximum value yMAX.

Then, on completion of processing up to S51, the PD unit 13 increments the X-axis address xadr by one to fix the minimum value+1, and executes processing from S47 to S51 for each address of the Y-axis address yadr from the minimum value yMIN to the maximum value yMAX.

Thereafter, the PD unit 13 repeats the above processing, and when the X-axis address xadr reaches the maximum value xMAX, the PD unit 13 fixes it to the maximum value xMAX, and executes processing from S47 to S51 for each address of the Y-axis address yadr from the minimum value yMIN to the maximum value yMAX.

The processing from S47 to S51 is executed similar to the example when the Y-axis address is fixed (FIG. 7 and FIG. 4, for example). Here, the PD unit 13 discriminates whether or not the distortion compensation coefficient at the address (xadr, yadr) is already updated (S47). When the Y-axis address is fixed, the distortion compensation coefficient at an address (xadr, yadr) may be updated (S41).

Then, according to the present third embodiment, it is configured to confirm, using the update flag, whether or not the update of the distortion compensation coefficient has been completed. With this, it is possible to prevent duplicated copy of the distortion compensation coefficient at S41 in FIG. 7 and S53 in FIG. 8, for example.

In the example depicted in FIG. 7, the distortion compensation coefficient copy unit 146, after copying the distortion compensation coefficient (S41), stores in the internal memory etc. the information of an update flag set ON for the address (xadr, yadr) of a copy target (S42). Then, the distortion compensation coefficient copy unit 146, when counting the Y-axis address with a fixed X-axis address (S44, S46), discriminates whether or not the distortion compensation coefficient is already updated at the address (xadr, yadr), based on the update flag and the discrimination result of the update of the distortion compensation coefficient from the update address counter 145.

FIG. 9 illustrates an example of the existence or non-existence of an updated distortion compensation coefficient at the X-axis address and the Y-axis address of the LUT 133a. As depicted in FIG. 9, by the execution of processing with a fixed Y-axis address (for example, FIG. 7), the copy of distortion compensation coefficient is executed in an area indicated by the downward arrows in the figure. Also, by the execution of processing with a fixed X-axis address (for example, FIG. 8), the copy of distortion compensation coefficient is executed in an area indicated by the right direction arrows in FIG. 9.

With reference back to FIG. 8, on completion of both the distortion compensation coefficient copy loop 04 and the distortion compensation coefficient copy loop 03 (S51, S55), the PD unit 13 completes a series of processing (S56).

According to the third embodiment, the PD unit 13 executes the distortion compensation coefficient copy control with each fixed Y-axis address (for example, FIGS. 4, 7) and further the distortion compensation coefficient copy control with each fixed X-axis address (for example, FIG. 8). By this, it is possible to copy to an area in which copy has not been possible by the distortion compensation coefficient copy control with the fixed Y-axis address, like an area indicated by the right direction arrow in FIG. 9, for example.

Therefore, the PD unit 13 in the present third embodiment can suppress the occurrence of the spurious in a wider range of the address area of the LUT 133a than the example of the second embodiment.

### Fourth Embodiment

In the second embodiment, the description is given on the example in which the X-axis address is shifted from the minimum value to the maximum value (or positive direction: hereafter may be referred to as positive direction). In the following fourth embodiment, a description will be given on an example in which the X-axis address is shifted from the maximum value to the minimum value (or negative direction: hereafter may be referred to as negative direction).

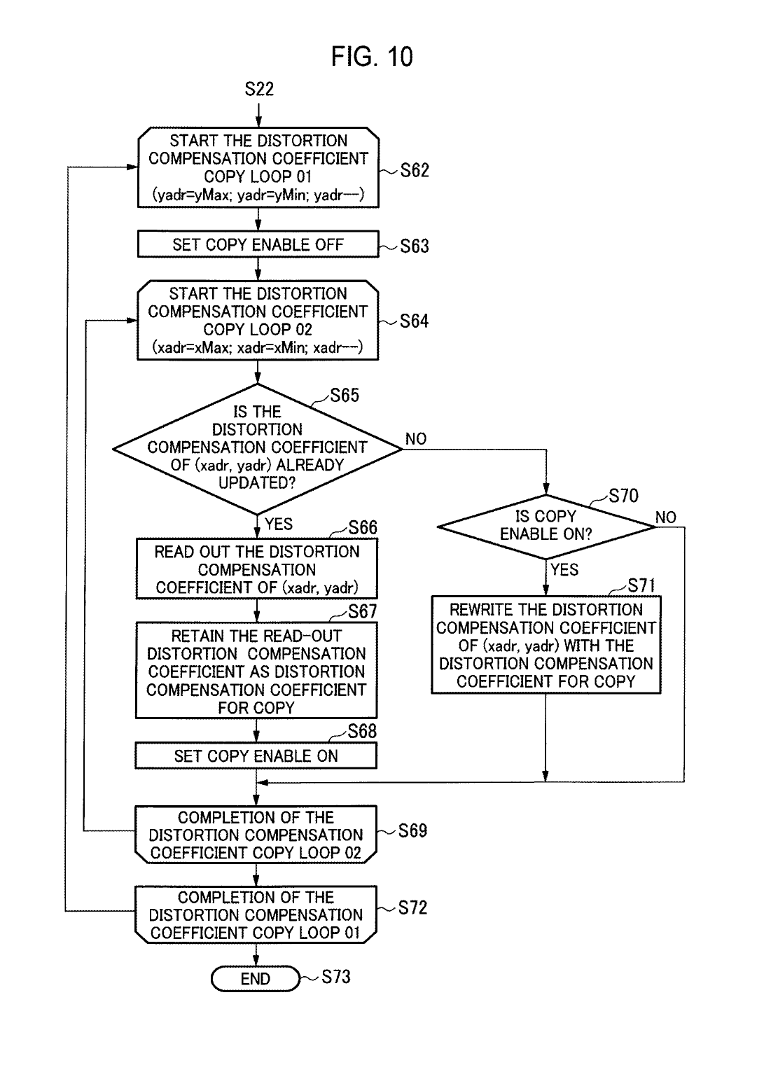

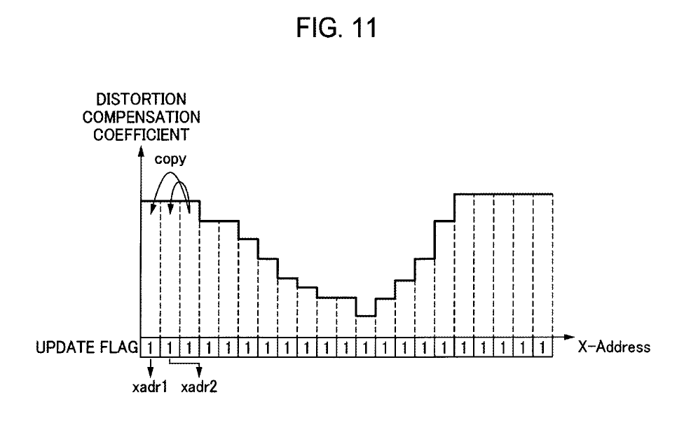

An example of distortion compensation coefficient copy control in the present fourth embodiment will be described. FIGS. 4 and 10 are flowcharts illustrating operation examples of the distortion compensation coefficient copy control according to the fourth embodiment. In the present fourth embodiment, processing is executed by fixing the Y-axis address of the LUT 133a and by shifting the X-axis address of the LUT 133a to the positive direction, and after shifting the X-axis address to the maximum value, processing is executed by shifting it to the negative direction.

In the fourth embodiment, the PD unit 13 first executes the distortion compensation coefficient copy control as explained in the second embodiment. For example, the PD unit 13 executes processing from S10 to S22 depicted in FIG. 4.

Next, the PD unit 13 shifts to S61 in FIG. 10 to execute a distortion compensation coefficient copy loop 01 (S62) and a distortion compensation coefficient copy loop 02 (S64).

Using the distortion compensation coefficient copy loop 01 (S62) and the distortion compensation coefficient copy loop 02 (S64), the PD unit 13 executes the following processing, for example. Namely, the PD unit 13, with a Y-axis address yadr of the LUT 133a fixed to the maximum value yMAX, decrements an X-axis address xadr one by one from the maximum value xMAX, to execute processing from S65 to S69 up to the minimum value xMIN. Next, with a Y-axis address yadr fixed to the maximum value yMAX−1, the PD unit 13 decrements an X-axis address one by one from the maximum value xMAX, to execute the processing from S65 to S69 up to the minimum value xMIN. The PD unit 13 successively repeats the above processing, and when the Y-axis address yadr reaches the minimum value yMIN, the PD unit 13, with fixation to the minimum value yMIN, decrements the X-axis address one by one from the maximum value xMAX, to execute the processing S65 to S69 up to the minimum value xMIN.

The processing from S65 to S69 is similar to the processing in the second embodiment (S15-S19 in FIG. 4), and therefore the description is omitted.

According to the present fourth embodiment, because processing can be advanced not only to the positive direction but to the negative direction of the X-axis address, it is possible to update the distortion compensation coefficient even in an area in which copy of the distortion compensation coefficient is incapable by the processing in the positive direction.

For example, as for the X-axis addresses xadr1, xadr2 in FIG. 5A, copy of the distortion compensation coefficient is not possible in the second embodiment. However, by the processing of the present fourth embodiment, it is possible to update the distortion compensation coefficient for the X-axis addresses xadr1, xadr2.

Accordingly, the PD unit 13 according to the present fourth embodiment can suppress the occurrence of the spurious in a wider range of the address area of the LUT 133a than the example of the second embodiment.

### Fifth Embodiment

In the third embodiment, the description is given on the example of processing executed in the positive direction of the X-axis address with a fixed Y-axis address of the LUT 133a, followed by execution in the positive direction of the Y-axis address with a fixed X-axis address. In the present fifth embodiment, there is illustrated an example in which, after the processing according to the third embodiment, processing is executed in the negative direction of the X-axis address with a fixed Y-axis address of the LUT 133a, followed by execution in the negative direction of the Y-axis address with a fixed X-axis address.

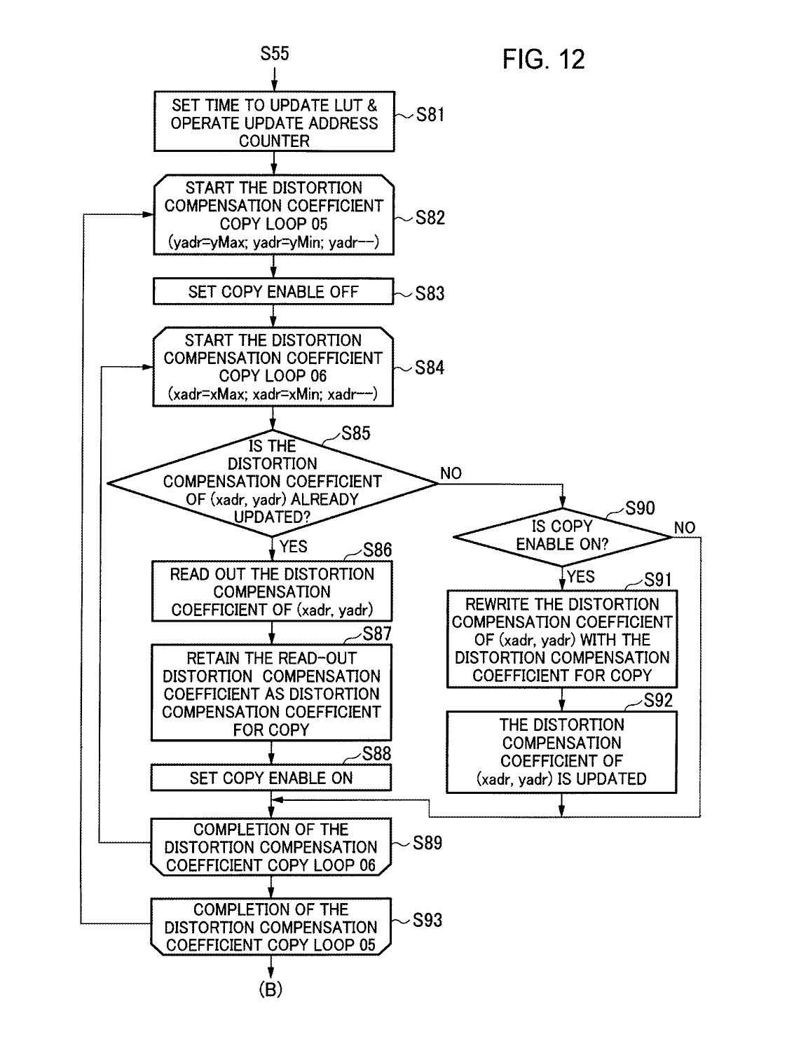

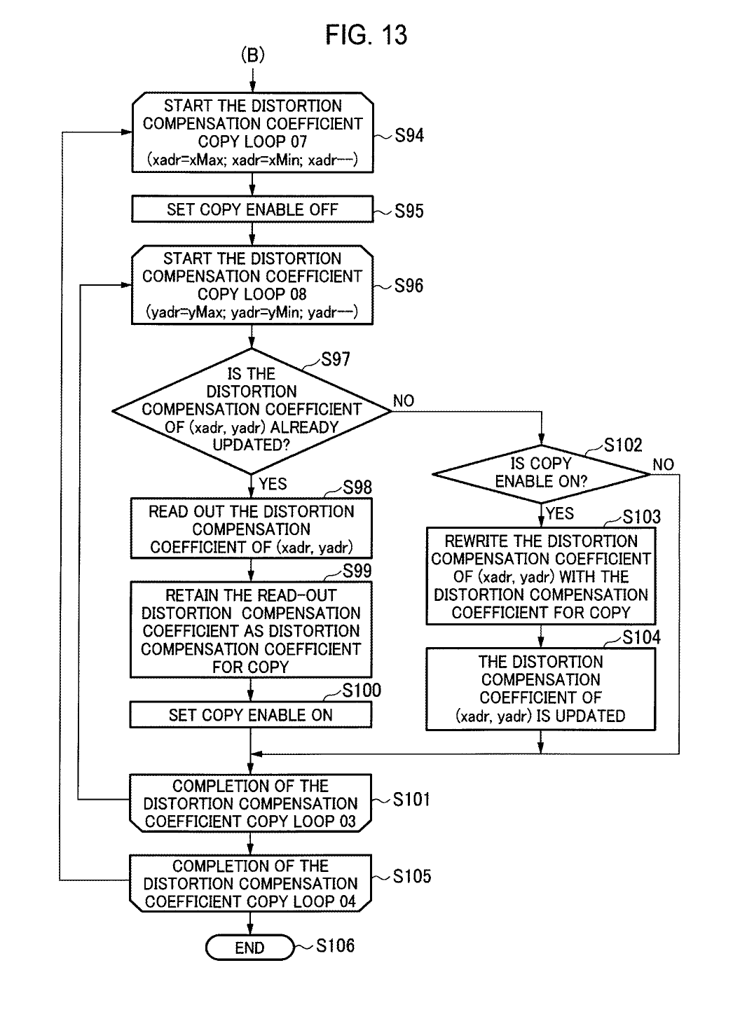

In the distortion compensation coefficient copy control according to the present fifth embodiment, the PD unit 13 first executes processing from S30 of FIG. 7 to S55 of FIG. 8, for example. Next, the PD unit 13 executes processing depicted in FIGS. 12, 13.

By the processing depicted in FIG. 12, the PD unit 13 executes processing in the negative direction of the X-axis address with a fixed Y-axis address of the LUT 133a (S81-S93). The above processing (S81-S93) is similar to the processing according to the fourth embodiment (for example, FIG. 10), excluding the processing (S92) in which the PD unit 13 sets the update flag to be “update completed”.

Further, by the processing depicted in FIG. 13, the PD unit 13 executes processing in the negative direction of the Y-axis address with a fixed X-axis address of the LUT 133a (S94-S105).

Using a distortion compensation coefficient copy loop 07 (S94) and a distortion compensation coefficient copy loop 08 (S96), the PD unit 13 executes the following processing, for example.

Namely, the PD unit 13, with an X-axis address xadr of the LUT 133a fixed to the maximum value xMAX, decrements the Y-axis address yadr one by one from the maximum value yMAX, to execute processing from S97 to S101 up to the minimum value yMIN.

Next, with an X-axis address xadr fixed to the maximum value xMAX-1, the PD unit 13 decrements the Y-axis address one by one from the maximum value yMAX, to execute the processing from S97 to S101 up to the minimum value yMIN.

The PD unit 13 successively repeats the above processing, and when the X-axis address xadr reaches the minimum value xMIN, the PD unit 13, with fixation to the minimum value xMIN, decrements the Y-axis address yadr one by one from the maximum value xMAX, to execute the processing S97 to S101 up to the minimum value yMIN.

The processing from S97 to S101 is similar to the processing in the second embodiment (S15-S19 in FIG. 4), and therefore the description is omitted.

According to the present fifth embodiment, because processing can be advanced not only to the positive direction of the X-axis address of the LUT 133a but to the negative direction thereof, and further, not only to the positive direction of the Y-axis address but to the negative direction thereof, it is possible to update the distortion compensation coefficients throughout the whole area of the LUT 133a, for example.

Accordingly, the PD unit 13 in the present fifth embodiment can suppress the occurrence of the spurious in a wider range of the address area of the LUT 133a than the example of the second embodiment.

### Sixth Embodiment

In the above-mentioned second to fifth embodiments, as for an access to the X-axis address of the LUT 133a, the descriptions have been given on the examples in which update and readout is executed using the to power value of the input signal x(t) as the X-axis address.

There is also an opposite case to access the LUT 133a. Namely, the X-axis address of the LUT 133a takes a minimum address value in the case the input signal x(t) is a maximum power value, and the X-axis address takes a maximum address value in case the input signal x(t) is a minimum power value, for example.

Even in the case when such an access is made, it is possible to implement the above-mentioned second to fifth embodiments in the PD unit 13. For example, in the second embodiment, it is possible for the PD unit 13 to execute processing to the negative direction of the X-axis address of the LUT 133a from the maximum value xMAX to the minimum value xMIN, with a fixed Y-axis address of the LUT 133a. Also, in the third embodiment, it is possible for the PD unit 13 to execute processing to the negative direction of the X-axis address with a fixed Y-axis address, and thereafter, execute processing to the negative direction of the Y-axis address from the minimum value yMIN to the maximum value yMAX, with a fixed X-axis address. Also in the fourth and fifth embodiments, the PD unit 13 may execute processing by replacing processing that has been advanced to the positive direction with processing to the negative direction, and vice versa.

Thus, even in the case when such an access is made, if the distortion compensation coefficient is not updated within the range of the LUT 133a from the minimum reference value to the maximum reference value, whereas each distortion compensation coefficient before and after an address has been updated, the PD unit 13 can update the distortion compensation coefficient of the address of concern. Thus, the PD unit 13 can reduce the occurrence of the spurious.

### Seventh Embodiment

In the above-mentioned second to fifth embodiments, the descriptions are given on each example of a two-dimensional access of the LUT 133a, that is, an access by the X-axis address and the Y-axis address. It is also possible to implement the second to fifth embodiments using a three-dimensional LUT composed of the X-axis, the Y-axis and a Z-axis, or a four-dimensional LUT composed of the X-axis, the Y-axis, a Z-axis and a W-axis. For example, a signal phase component may be applicable for the Z-axis, and a moving average value of signal power may be applicable for the W-axis.

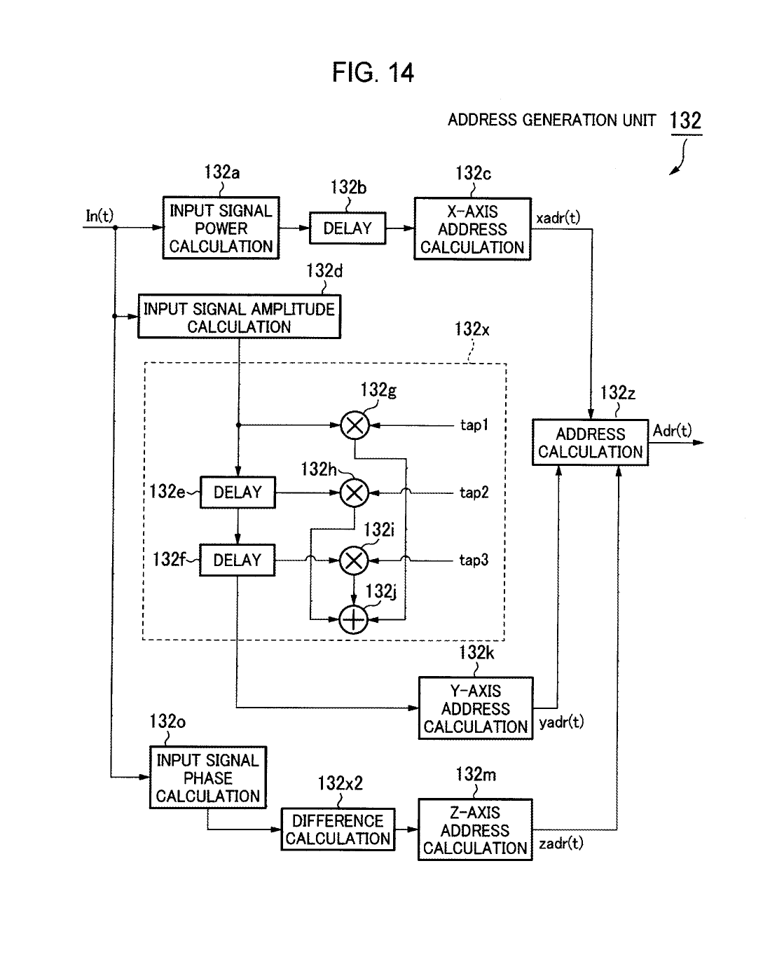

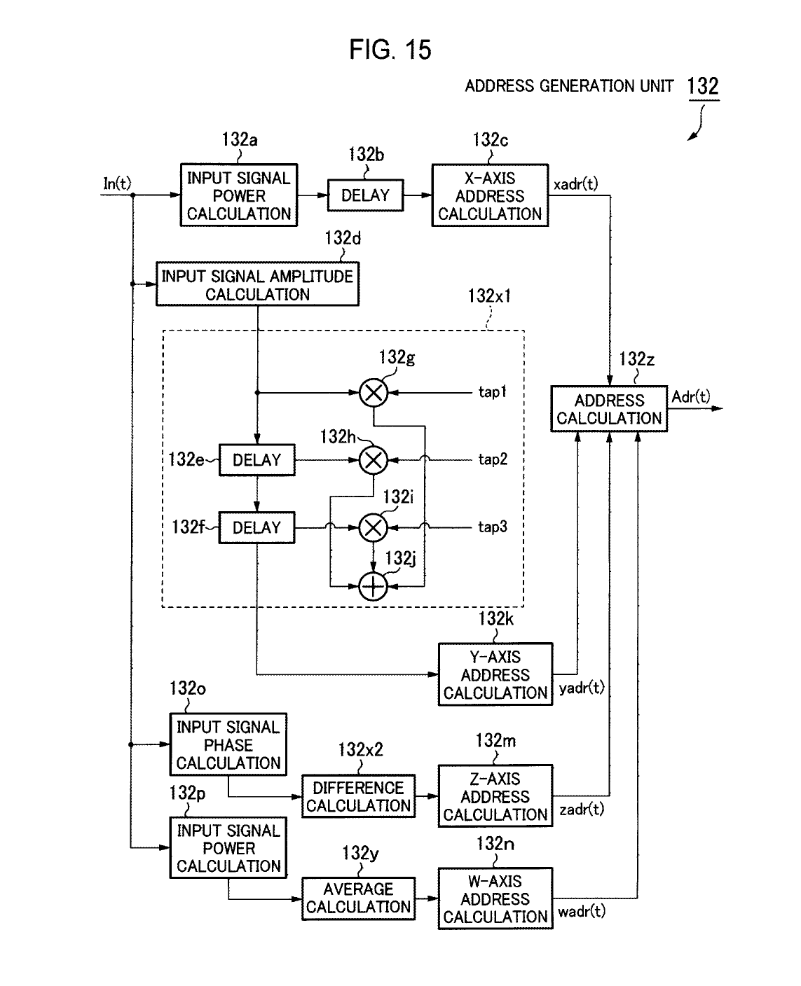

FIG. 14 illustrates a configuration example of an address generation unit 132 in the case of a three-dimensional LUT, and FIG. 15 illustrates a configuration example of an address generation unit 132 in the case of a four-dimensional LUT, respectively.

As depicted in FIG. 14, the address generation unit 132 further includes an input signal phase calculation unit 1320, a difference calculation unit 132x2 and a Z-axis address calculation unit 132m.

The input signal phase calculation unit 1320 calculates the phase of an input signal x(t). For example, the phase calculation is performed using a coedic method, a table lookup method, etc.

For example, the difference calculation unit 132x2 includes delay units 132e, 132f, multiplier units 132g-132i and an adder unit 132j, and is of the same configuration as a difference calculation unit 132x1 for the input signal phase amplitude unit 132d. The difference calculation unit 132x2 receives the phase information of the input signal x(t) from the input signal phase calculation unit 132o, and calculates a phase difference to output to the Z-axis address calculation unit 132m.

The Z-axis address calculation unit 132m normalizes the phase difference and calculates a Z-axis address zadr(t) based on the phase of the input signal x(t), to output to the address calculation unit 132z. The address calculation unit 132z then generates a composite address Adr(t) of three addresses xadr(t), yadr(t) and zadr(t), to output to the table management unit 133.

In the case of the three dimension, distortion compensation coefficient copy control (FIG. 4, for example) is executed in the following manner, for example. An update address counter 145 fixes a Z-axis address and a Y-axis address to each minimum value, and counts each X-axis address from the minimum value to the maximum value. Next, the update address counter 145 fixes the Z-axis address to the minimum value and also fixes the Y-axis address to the minimum value+1, and counts the X-axis address. Thereafter, on completion of counting the X-axis address with a Y-axis address fixed to the maximum value, the update address counter 145 executes address count with a Z-axis address fixed to the minimum value+1 and a Y-axis address fixed to the minimum value, and so on. For each counted address, a distortion compensation coefficient copy unit 146 executes processing from S15 to S19 (FIG. 4, for example). As described in the third and fourth embodiments, the update address counter 145 may execute address count not only to the positive direction but to the negative direction, or may execute in combination of the positive direction with the negative direction.

In the case of the four dimension, an address generation unit 132 further includes an input signal power calculation unit 132p, an average calculation unit 132y and a W-axis address calculation unit 132n.

The input signal power calculation unit 132p calculates the signal power of an input signal x(t). For example, the input signal power calculation unit 132p determines the input signal power by adding each power value (=x²(t)) of the input signal x(t) for a predetermined period.

The average calculation unit 132y receives a plurality of samples of input signal power, and recursively calculates the average value of the input signal power, so as to obtain the moving average value of the input signal power.

The W-axis address calculation unit 132n normalizes the moving average value of the input signal power to calculate a W-axis address wadr(t). An address calculation unit 132z generates a composite address Adr(t) of four addresses xadr(t), yadr(t), zadr(t) and wadr(t) to output to the table management unit 133.

In the case of the four dimension also, the update address counter 145 fixes each address of the W-axis, the Z-axis and the Y-axis to the minimum value, and counts each X-axis address successively. On completion of counting the X-axis address, the update address counter 145 fixes each address of the W-axis and the Z-axis to the minimum value, and also fixes the Y-axis address to the minimum value+1, to count the X-axis address. Then, on completion of counting the Y-axis address up to the maximum value thereof, the update address counter 145 fixes each address of the W-axis and the Y-axis to each minimum value, and also fixes a Z-axis address to the minimum value+1, to count the X-axis address. On completion of counting each Z-axis address to the maximum address, the update address counter 145 fixes a W-axis address to the minimum value+1, and also each address of the Z-axis and the X-axis to each minimum value, to successively execute address count. For each counted address, the distortion compensation coefficient copy unit 146 executes processing from S15 to S19. As described in the third and fourth embodiments, the update address counter 145 may execute address count not only to the positive direction but to the negative direction, or may execute in combination of the positive direction with the negative direction.

In addition to the three dimension and the four dimension, it may also be possible to execute address readout using an LUT 133a of a five dimension or higher. In this case, the update address counter 145, while fixing the address of each axis corresponding to each dimension, counts the X-axis address from the maximum value to the minimum value, so as to count until each address of other axes reaches each maximum value. For each counted address, the distortion compensation coefficient copy unit 146 executes processing from S15 to S19.

### Other Embodiments

In the above-mentioned embodiments, the descriptions have been given on the example in which, for an address in which no distortion compensation coefficient is stored, the distortion compensation coefficient copy unit 146 copies from an address in which a distortion compensation coefficient is stored and whose address number is smaller (or larger) than, and nearest to, the address of concern in which no distortion compensation coefficient is stored.

For example, in the example depicted in FIG. 5, as a distortion compensation coefficient to be stored to xadr5, the distortion compensation coefficient copy unit 146 may copy the distortion compensation coefficient stored at xadr3, instead of xadr4. Also, as a distortion compensation coefficient to be stored to xadr11, the distortion compensation coefficient copy unit 146 may copy the distortion compensation coefficient stored at any one of xadr3-4 and xadr6-9.

As such, the distortion compensation coefficient copy unit 146 may copy the distortion compensation coefficient not only from an address, that stores a distortion compensation coefficient and is located nearest to the address of concern, but also from another address that stores a distortion compensation coefficient.

In the above-mentioned examples, the distortion compensation coefficient copy unit 146 determines an address of the LUT 133a, in which no distortion compensation coefficient is stored, to be a copy target. For example, it may be possible for the distortion compensation coefficient copy unit 146 to count the number of times when the distortion compensation coefficient is copied to each address (xadr, yadr) of the LUT 133a, to determine the address of concern to be a copy target if the above count value is a predetermined number or smaller. In this case, it may also be possible that, if the count value is larger than the predetermined number, the distortion compensation coefficient copy unit 146 excludes the address of concern from the copy target.

The radio communication apparatus 10 explained in the above-mentioned examples may be achieved by a hardware configuration as described below.

FIG. 16 illustrates an exemplary hardware configuration of the to radio communication apparatus 10. The radio communication apparatus 10 includes a radio equipment control (REC) 10a and radio equipment (RE) 10b.

The radio equipment 10b includes an FPGA (field programmable gate array) 10c, an MPU (micro processing unit or processor) 10d, a DAC (digital to analog converter) 10e, a PA 10g, an ADC (analog to digital converter) 10i, a connector 10j and a memory 10k.

The FPGA 10c and the MPU 10d are connected in a manner to enable inputting/outputting a variety of signals and data.

The memory 10k is, for example, a RAM such as an SDRAM (synchronous dynamic random access memory), a ROM (read only memory), a flash memory, etc.

The PD unit 13 described in the second to fifth embodiments corresponds to the FPGA 10c, the MPU 10d and the memory 10k, for example. In the PD unit 13, the table management unit 133 corresponds to the memory 10k, for example. Further, the multiplier unit 131, the address generation unit 132, the distortion compensation coefficient calculation unit 134, the subtractor unit 136, the adder unit 140, the delay units 141-143, the update address counter 145 and the distortion compensation coefficient copy unit 146 correspond to the FPGA 10c and the MPU 10d, for example.

Also, the transmission signal generator unit 11 and the S/P converter unit 12 correspond to the FPGA 10c, the MPU 10d and the memory 10k, for example. Here, the transmission signal generator unit 11 may be provided in the REC 10a, for example.

Further, for example, the D/A converter unit 15 corresponds to the DAC 10e, the PA 16 corresponds to the PA 10g, and the A/D converter unit 18 corresponds to the ADC 10i, respectively.

In place of the MPU and the FPGA, a CPU (central processing unit or processor) may be available.

Thus, it is possible to provide a distortion compensation apparatus, a distortion compensation method, and a radio communication to apparatus, configured to reduce the occurrence of the spurious.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A distortion compensation apparatus for compensating distortion of an input signal by an amplifier, the apparatus comprising:
a storage unit configured to store a distortion compensation coefficient;
a distortion compensation processing unit configured to read the distortion compensation coefficient from the storage unit based on a plurality of first addresses each corresponding to power of the input signal and perform distortion compensation on the input signal; and
a distortion compensation coefficient copy unit configured to store the distortion compensation coefficient stored at a third address to a second address in which no distortion compensation coefficient is stored, between a maximum address and a minimum address of the storage unit storing the distortion compensation coefficients out of plurality of first addresses.

2. The distortion compensation apparatus according to claim 1, wherein
the distortion compensation coefficient copy unit is configured to store to the second address the distortion compensation coefficient stored at the third address whose address number is smaller than the second address.

3. The distortion compensation apparatus according to claim 2, wherein
the distortion compensation coefficient copy unit is configured to store the distortion compensation coefficient stored at the maximum address to an address whose address number is larger than the maximum address of the storage unit storing the distortion compensation coefficient.

4. The distortion compensation apparatus according to claim 3, wherein
the distortion compensation coefficient copy unit is configured to store the distortion compensation coefficient stored at the minimum address, to an address whose address number is smaller than the minimum address of the storage unit storing the distortion compensation coefficient.

5. The distortion compensation apparatus according to claim 2, wherein
the third address is an address whose address number is smaller than the second address and which is nearest to the second address out of the addresses in which the distortion compensation coefficients are stored.

6. The distortion compensation apparatus according to claim 1, wherein
the distortion compensation coefficient copy unit is configured to store to the second address the distortion compensation coefficient stored at the third address whose address number is larger than the second address.

7. The distortion compensation apparatus according to claim 1, wherein
the distortion compensation processing unit is configured to read distortion compensation coefficient from the storage unit based on the plurality of first addresses and a plurality of fourth addresses each corresponding to a phase or amplitude of the input signal and perform distortion compensation, and
the distortion compensation coefficient copy unit is configured to store the distortion compensation coefficient stored at the third address to the second address in which no distortion compensation coefficient is stored out of the plurality of first addresses, for each address from the minimum address to the maximum address of the storage unit storing the distortion compensation coefficients out of the plurality of fourth addresses.

8. The distortion compensation apparatus according to claim 7, wherein
the distortion compensation coefficient copy unit is configured to perform processing to store the distortion compensation coefficient stored at the third address to the second address in which no distortion compensation coefficient is stored, successively from the minimum address to the maximum address of the storage unit storing the distortion compensation coefficient out of the plurality of fourth addresses, for an address of the storage unit storing the distortion compensation coefficient out of the plurality of fourth addresses and for each address from the minimum address to the maximum address of the storage unit storing the distortion compensation coefficient out of the plurality of first addresses.

9. The distortion compensation apparatus according to claim 8, wherein
the distortion compensation coefficient copy unit is configured to further perform processing to store the distortion compensation coefficient stored at the third address to the second address in which no distortion compensation coefficient is stored, successively from the minimum address to the maximum address of the storage unit storing the distortion compensation coefficient out of the plurality of first addresses, for an address of the storage unit storing the distortion compensation coefficient out of the plurality of first addresses and for each address from the minimum address to the maximum address of the storage unit storing the distortion compensation coefficient out of the plurality of fourth addresses.

10. The distortion compensation apparatus according to claim 8, wherein
the distortion compensation coefficient copy unit is configured to further perform processing to store the distortion compensation coefficient stored at the third address to the second address in which no distortion compensation coefficient is stored, successively from the maximum address to the minimum address of the storage unit storing the distortion compensation coefficient out of the plurality of fourth addresses, for an address of the storage unit storing the distortion compensation coefficient out of the plurality of fourth addresses and for each address from the maximum address to the minimum address of the storage unit storing the distortion compensation coefficient out of the plurality of first addresses.

11. The distortion compensation apparatus according to claim 9, wherein
the distortion compensation coefficient copy unit is configured to further perform processing to store the distortion compensation coefficient stored at the third address to the second address in which no distortion compensation coefficient is stored, successively from the maximum address to the minimum address of the storage unit storing the distortion compensation coefficient out of the plurality of fourth addresses, for an address of the storage unit storing the distortion compensation coefficient out of the plurality of fourth addresses and for each address from the maximum to address to the minimum address of the storage unit storing the distortion compensation coefficient out of the plurality of first addresses, and
the distortion compensation coefficient copy unit is configured to perform processing to store the distortion compensation coefficient stored at the third address to the second address in which no distortion compensation coefficient is stored, successively from the maximum address to the minimum address of the storage unit storing the distortion compensation coefficient out of the plurality of first addresses, for an address of the storage unit storing the distortion compensation coefficient out of the plurality of first addresses and for each address from the maximum address to the minimum address of the storage unit storing the distortion compensation coefficient out of the plurality of fourth addresses.

12. The distortion compensation apparatus according to claim 1, wherein
the distortion compensation processing unit is configured to read distortion compensation coefficient from the storage unit based on the plurality of first addresses, a fifth address corresponding to a phase of the input signal, and a sixth address corresponding to amplitude of the input signal, and perform distortion compensation, and
the distortion compensation coefficient copy unit is configured to store the distortion compensation coefficient stored at the third address to the second address in which no distortion compensation coefficient is stored out of the first addresses, for each address from the minimum address to the maximum address of the storage unit storing the distortion compensation coefficient out of the fifth and the sixth addresses

13. The distortion compensation apparatus according to claim 1, wherein
the distortion compensation processing unit is configured to read from the storage unit the distortion compensation coefficient based on each dimensional address of n-dimensional addresses for the input signal (n is an integer greater than and including 2), with the first addresses defined to be one-dimensional addresses, and perform distortion compensation, and
the distortion compensation coefficient copy unit is configured to store the distortion compensation coefficient stored at the third address to the second address in which no distortion compensation coefficient is stored out of the first addresses, for each address from the minimum address to the maximum address of the storage unit storing the distortion compensation coefficient out of other addresses than the first addresses.

14. A distortion compensation method in a distortion compensation apparatus including a storage unit which stores a distortion compensation coefficient and for reading the distortion compensation coefficient from the storage unit based on a plurality of first addresses each corresponding to power of the input signal and performing distortion compensation on the input signal, to compensate distortion of the input signal by an amplifier, the distortion compensation method comprising:
storing the distortion compensation coefficient stored at a third address to a second address in which no distortion compensation coefficient is stored, between a maximum address and a minimum address of the storage unit storing the distortion compensation coefficient out of the plurality of first addresses, by a distortion compensation coefficient copy unit.

15. A radio communication apparatus comprising:
an amplifier unit configured to amplify an input signal;
a storage unit configured to store distortion compensation coefficient;
a distortion compensation unit configured to read the distortion compensation coefficient from the storage unit based on a plurality of first addresses each corresponding to power of the input signal and perform distortion compensation on the input signal to compensate distortion of the input signal by the amplifier unit;
a transmitter configured to transmit the distortion compensated input to signal; and
a distortion compensation coefficient copy unit configured to store the distortion compensation coefficient stored at a third address to a second address in which no distortion compensation coefficient is stored, between a maximum address and a minimum address of the storage storing the distortion compensation coefficient out of the plurality of first addresses.

16. The distortion compensation apparatus according to claim 1, the apparatus comprising:
a memory configured, as the storage unit, to store distortion compensation coefficient; and
a processor configured, as distortion compensation unit and the distortion compensation coefficient copy unit, to read the distortion compensation coefficient from the storage unit based on a first address corresponding to power of an input signal, perform distortion compensation on the input signal, and store the distortion compensation coefficient stored at a third address to a second address in which no distortion compensation coefficient is stored, between a maximum address and a minimum address of the storage storing the distortion compensation coefficient out of the first address.
